(19) United States
(12) Patent Application Publication
(10) Pub. No.: US 2002/0135575 A1
(43) Pub. Date: Sep. 26, 2002

(54) Liquid crystal driving power supply

(76) Inventor: Mikiya Mizuno, Nagoya-shi (JP)

Correspondence Address: HOGAN & HARTSON L.L.P., 500 S. GRAND AVENUE, SUITE 1900, LOS ANGELES, CA, 90071-2611, US

(21) Appl. No.: 09/755,883

(22) Filed: May 18, 2001

(30) Foreign Application Priority Data
Jan. 7, 2000 (JP) 2000-1802(P)
Mar. 13, 2000 (JP) 2000-69406(P)

(51) Int. Cl. G09G 5/00

(52) U.S. Cl. 345/211

(57) ABSTRACT

A liquid crystal driving power supply has serially connected resistors R1˜R5 that divide a DC output voltage VOUT 2, and outputs the divided voltages through voltage followers 131˜134 as output voltages V1˜V4 to drivers of a liquid crystal display apparatus. Both ends of the resistor R3 are connected to adjusting terminals 27 and 28 that are connectable to an external adjusting resistor R0, such as a variable resistor, for finely adjusting the brightness of a display screen of the liquid crystal display apparatus. When the adjusting resistor R0 is a variable resistor, the resistance value of the resistor R3 can be finely adjusted such that the divided voltages can be finely adjusted and the brightness of the display screen of the liquid crystal display apparatus.

### TECHNICAL FIELD

The present invention relates to a liquid crystal driving power supply that is used for a liquid crystal display apparatus, and more particularly to a liquid crystal driving power supply in which a specified voltage is divided by a plurality of resistances, and the divided voltages are supplied as driving voltages for drivers of a liquid crystal display apparatus.

### BACKGROUND TECHNOLOGY

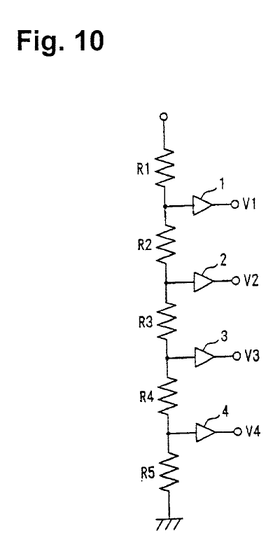

For example, one of the known liquid crystal driving power supply of this type has serially connected resistors R1˜R5 that divide a given voltage as shown in FIG. 10. The divided voltages are respectively outputted through buffers 1˜4 to provide output voltages V1˜V4 that are supplied as driving voltages for drivers of a liquid crystal display (not shown). The resistors R1, R2, R4 and R5 among the resistors R1˜R5 have the same resistance value R, and the resistor R3 has a resistance value of nR, which is n times the resistance value R.

It is noted that, in the conventional liquid crystal driving power supply, the resistors R1˜R5 are fixed resistors. This results in a problem in that the brightness (contrast) of the display screen of the liquid crystal display apparatus cannot be finely adjusted. Therefore, solutions to the problem have been sought.

In view of the above, it is a first object of the present invention to provide a liquid crystal driving power supply that enables fine adjustment of the brightness of a display screen of a liquid crystal display apparatus.

Also, it is a second object of the present invention to provide a liquid crystal driving power supply that can reduce the power consumption without lowering the display condition of a liquid crystal display apparatus.

### SUMMARY OF THE INVENTION

The present invention provides a liquid crystal driving power supply in which a given voltage is divided by N number of resistors, and the divided voltages are outputted as driving voltages for drivers of a liquid crystal display apparatus. The liquid crystal driving power supply of the present invention is characterized in that the N number of resistors consist of (N−1) number of first resistors having an identical resistance value and a second resistor having a resistance value that is n times the resistance value of the first resistors, the resistors are serially connected to one another in a manner that the second resistor is generally located intermediate among the resistors, and both ends of the second resistor are connected to adjusting terminals that are connectable to an adjusting resistor.

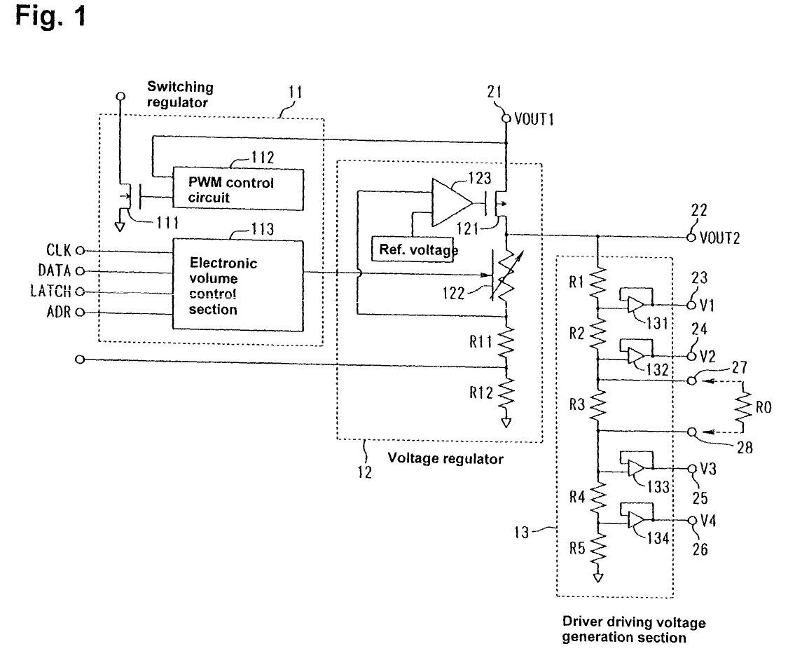

When we say that the second resistor is generally located intermediate among the resistors, such statement means not only that the second resistor, for example, the resistor R3 shown in FIG. 1, is located in the center among the resistors, but also conceptually includes cases in which the resistor R3 is replaced with the resistor R2 or the resistor R4. The same concept applies to embodiments to be described below. In accordance with one embodiment of the present invention, the liquid crystal driving power supply may be characterized in that the adjusting resistor is a variable resistor.

In the manner described above, in the liquid crystal driving power supply of the present invention or the embodiment of the present invention, the adjusting terminals are connected to the both ends of the second resistor. As a result, when an adjusting resistor is connected to the adjusting terminals, the adjusting resistor is connected in parallel to the second resistor, whereby the resistance value of the second resistor can be changed. Accordingly, for example, when the adjusting resistor is a variable resistor, the resistance value of the second resistor can be finely adjusted and therefore the divided voltages can also be finely adjusted such that the brightness of the display screen of the liquid crystal display apparatus can be finely adjusted.

The present invention also provides a liquid crystal driving power supply in which a given voltage is divided by N number of resistors, and the divided voltages are outputted as driving voltages for drives of a liquid crystal display apparatus. The liquid crystal driving power supply of the present invention is characterized in that the N number of resistors consist of (N−1) number of first resistors having an identical resistance value and a second resistor having a resistance value that is n times the resistance value of the first resistors, the resistors are serially connected to one another in a manner that the second resistor is generally located intermediate among the resistors, and the second resistor is an electronic volume that is capable of electronically varying its resistance value based on externally supplied control data.

The liquid crystal driving power supply in accordance with one embodiment of the present invention is characterized in that the electronic volume is formed from a plurality of serially connected units, each of the units having a resistor and a switch element connected in parallel with each other. The switch element can be controlled and turned on and off by externally supplied control data.

In this manner, in the liquid crystal driving power supply of the present invention or the embodiment, the second resistance is formed from an electronic volume that is capable of electronically varying its resistance value based on externally supplied control data. As a result, when the resistance value of the second resistor is finely adjusted based on externally supplied control data, the divided voltages can also be finely adjusted such that the brightness of the display screen of the liquid crystal display apparatus can be finely adjusted.

The liquid crystal driving power supply in accordance with one embodiment of the present invention is characterized in that the divided voltages are outputted through voltage followers.

Furthermore, the present invention also provides a liquid crystal driving power supply in which a given voltage is divided by N number of resistors, and the divided voltages are outputted through buffers respectively as driving voltages for drivers of a liquid crystal display apparatus. Each of the buffers is capable of controlling its drivability in response to an externally supplied power control signal. The liquid crystal driving power supply has a power control signal generation device that generates the power control signal based on a liquid crystal alternation signal relative to a display on the liquid crystal display apparatus and outputs the power control signal to the respective buffers.

The liquid crystal alternation signal conceptually includes a frame signal that has characteristics similar to those of the liquid crystal alternation signal and relates to the display on the liquid crystal display apparatus.

The liquid crystal driving power supply in accordance with one embodiment of the present invention is characterized in that the power control signal generated by the power control signal generation device has a specified width extending before and after each of rises and falls of the liquid crystal alternation signal.

The liquid crystal driving power supply in accordance with one embodiment of the present invention is characterized in that the power control signal generation device has an edge detection section that detects a rise and a fall of the liquid crystal alternation signal, a counter section that performs a first count for a period between the rise and the fall of the liquid crystal alternation signal detected by the edge detection section and that, after the completion of the first count and each time when the edge detection section makes a detection of either the rise or the fall of the liquid crystal alternation signal, performs a second count starting from a specified initial value based on the detection, a latch section that stores a counted value of the first count after the counter section completes the first count, a comparator section that compares a counted value of the second count by the counter section and the counted value stored in the latch section, and provides an output when the counted value of the second count exceeds over the counted value stored in the latch section, a pulse generation section that, when the edge detection section makes a detection of either the rise or the fall of the liquid crystal alternation signal, generates a pulse having a specified width based on the detection, and a power control signal generation section that generates the power control signal based on the output of the comparator section and the pulse provided by the pulse generation section.

In this manner, in the liquid crystal driving power supply in accordance with the present invention or the embodiment, the power control signal generation device generates the power control signal based on a liquid crystal alternation signal relative to the display on the liquid crystal display apparatus, and outputs the power control signal to each of the buffers. As a result, the drivability of each of the buffers can be controlled within a range in which the display condition of the liquid crystal display apparatus is permissible, and can reduce the power consumption without lowering the display condition of the liquid crystal display apparatus.

### BRIEF DESCRIPTION OF THE INVENTION

FIG. 1 shows a circuit diagram of a structure of a liquid crystal driving power supply in accordance with a first embodiment of the present invention.

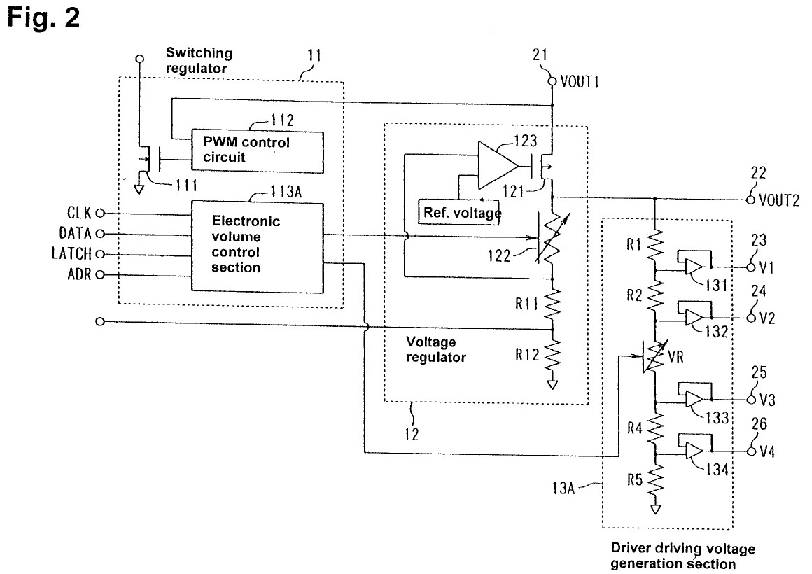

FIG. 2 shows a circuit diagram of a structure of a liquid crystal driving power supply in accordance with a second embodiment of the present invention.

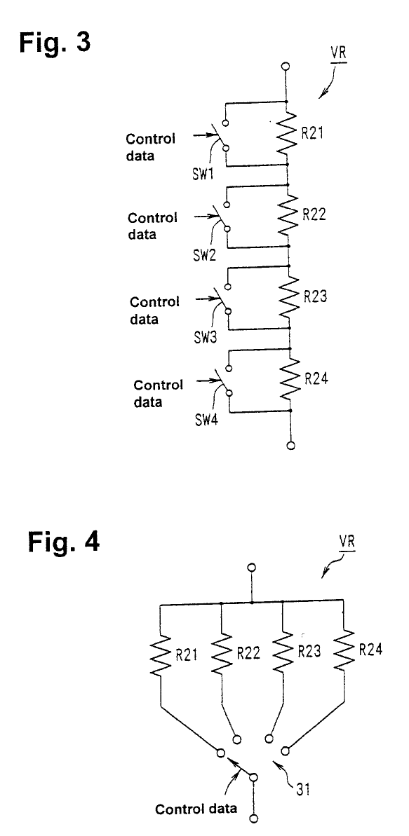

FIG. 3 shows one embodiment example of a structure of an electronic volume.

FIG. 4 shows another embodiment example of a structure of an electronic volume.

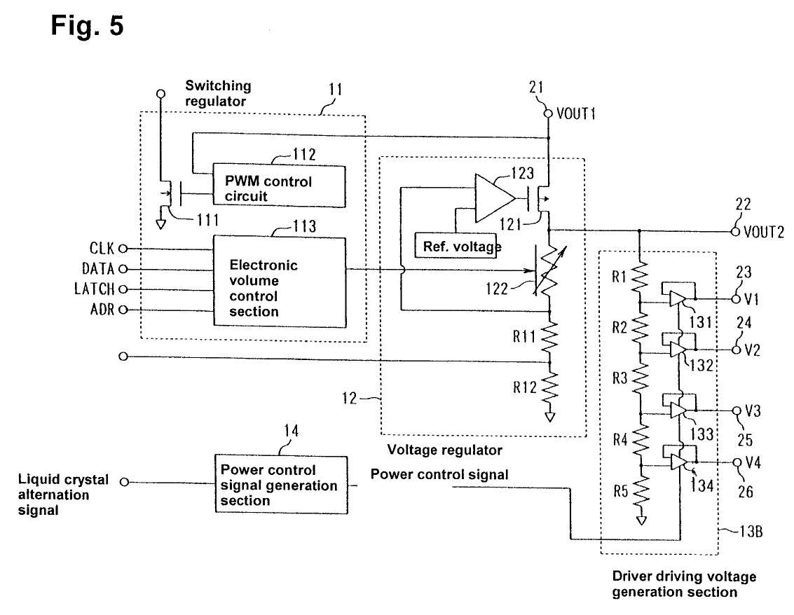

FIG. 5 shows a circuit diagram of a structure of a liquid crystal driving power supply in accordance with a third embodiment of the present invention.

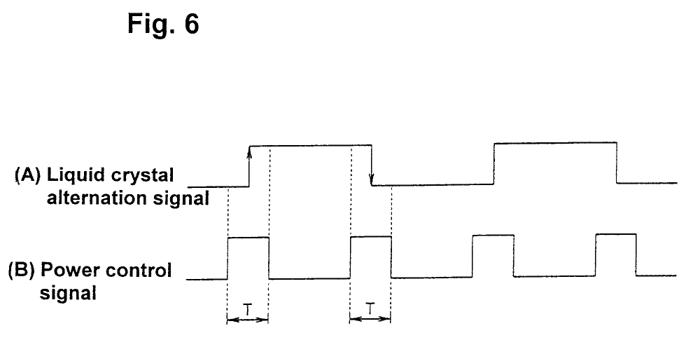

FIG. 6 shows a time chart of one example operation of a power control signal generation section shown in FIG. 5.

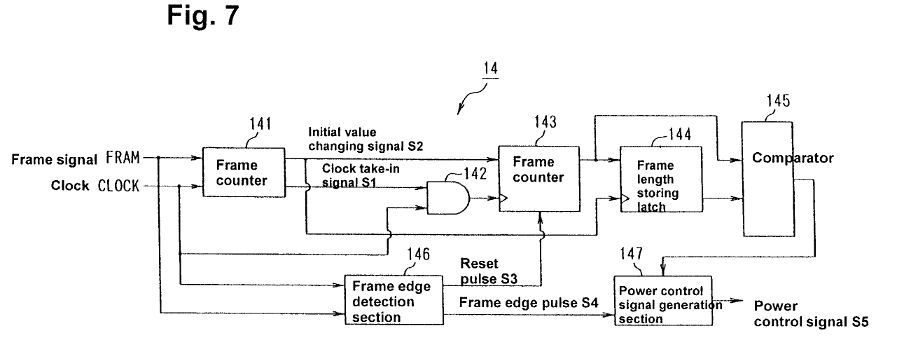

FIG. 7 shows a block diagram of one embodiment structure of a power control signal generation section.

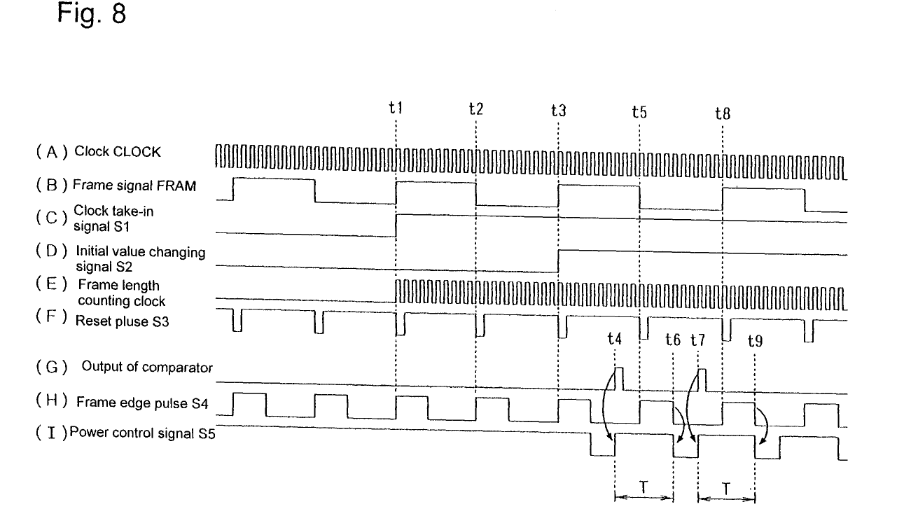

FIG. 8 shows a waveform figure indicating waveforms of respective sections of the power control signal generation section shown in FIG. 7.

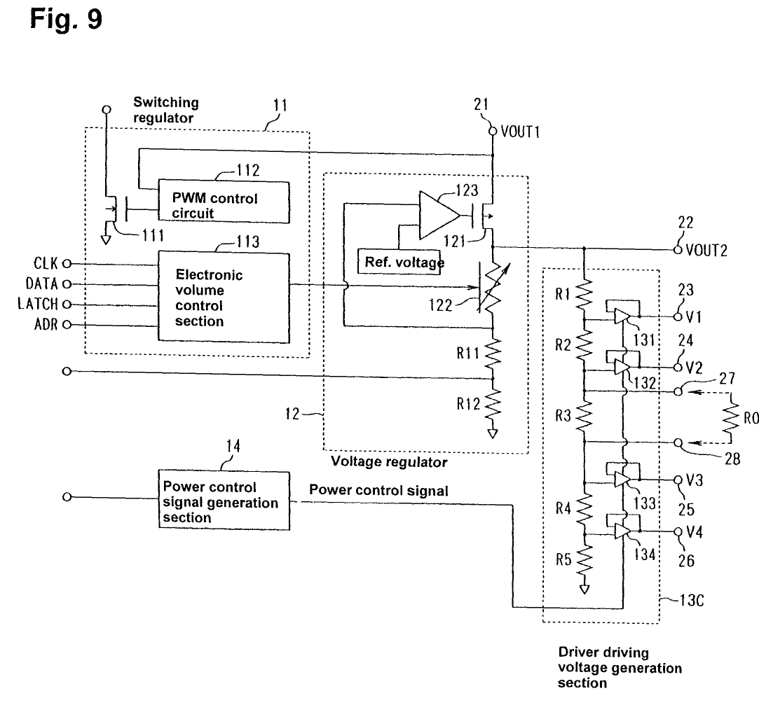

FIG. 9 shows a circuit diagram of a structure of a liquid crystal driving power supply in accordance with a fourth embodiment of the present invention.

FIG. 10 shows a circuit diagram of a conventional apparatus.

### BEST MODE EMBODIMENTS OF THE PRESENT INVENTION

Embodiments of the present invention will be described below with reference to the accompanying drawings.

A structure of a liquid crystal driving power supply in accordance with a first embodiment of the present invention is described with reference to a circuit diagram of FIG. 1.

As shown in FIG. 1, the liquid crystal driving power supply in accordance with the first embodiment of the present invention is equipped at least with a switching regulator 11, a voltage regulator 12 and a driver driving voltage generation section 13 that generates driving voltages for drivers of a black-and-white or color liquid crystal display apparatus, which are integrally formed into an integration circuit (in one-chip) on a semiconductor substrate.

The switching regulator 11 is equipped at least with a switch transistor 111 that is formed from a MOS transistor, a PWM control circuit 112 and an electronic volume control section 113, as shown in FIG. 1.

The PWM control circuit 112 compares a DC output voltage VOUT 1 provided from an output terminal 21 with a triangle wave and performs ON/OFF control of the switch transistor 111 by an ON/OFF signal obtained based on a result of the comparison to thereby stabilize the DC output voltage VOUT 1 to a specified value.

The electronic volume control section 113, upon receiving externally supplied control data DATA that varies the resistance value of an electronic volume 122 to be described below, varies the resistance value of the electronic volume 122 based on the control data DATA.

As shown in FIG. 1, the voltage regulator 12 has a switch transistor 121 that is formed from a MOS transistor, an electronic volume 122, a resistor R11 and a resistor R12 that are serially connected to one another between the output terminal 21 of the DC output voltage VOUT 1 and the grounding. Then, a comparator 123 compares the voltage at a common junction point of the electronic volume 122 and the resistor 11 (a divided voltage of the DC output voltage VOUT 1) with a reference voltage, and performs ON/OFF control of the switch transistor 121 by an ON/OFF signal corresponding to a result of the compression, to thereby stabilize a DC output voltage VOUT 2 that is outputted to an output terminal 22. The electronic volume 122 is capable of electronically varying its resistance value based on control data provided from the electronic volume control section 113.

The driver driving voltage generation section 13 generates driving voltages V1˜V4 to be supplied to drivers of a liquid crystal display apparatus (not shown). The driver driving voltage generation section 13 has, for example, resistors R1˜R5 serially connected between the output terminal 22 of the DC output voltage VOUT 2 of the voltage regulator 12 and the grounding, to thereby divide the DC output voltage VOUT 2 by the resistors R1˜R5.

Also, a common junction point of the resistor R1 and the resistor R2 is connected through a voltage follower 131 to an output terminal 23, and a common junction point of the resistor R2 and the resistor R3 is connected through a voltage follower 132 to an output terminal 24. Furthermore, a common junction point of the resistor R3 and the resistor R4 is connected through a voltage follower 133 to an output terminal 25, and a common junction point of the resistor R4 and the resistor R5 is connected through a voltage follower 134 to an output terminal 26.

The resistors R1˜R5 are formed from the resistors R1, R2, R4 and R5 that define first resistors having the same resistance value R, and the resistor R3 that defines a second resistor having a resistor value that is n times the resistance value R, i.e., nR. It is noted that, although this example uses five resistors R1 through R5, the present invention is not limited to this example. Also, the position of the resistor R3 is not limited to the position shown in FIG. 1, but may be replaced with the resistor R2 or the resistor R4.

Furthermore, in the driver driving voltage generation section 13, as shown in FIG. 1, both ends of the resistor R3 are connected to adjusting terminals 27 and 28 that are connectable to an external adjusting resistor R0 for fine adjustment of the brightness of the display screen of the liquid crystal display apparatus. The external adjusting resistor R0 may be formed from a fixed resistor having a fixed resistance value or a variable resistor that is capable of varying its resistance value.

Next, an operation of the first embodiment thus structured will be described below with reference to FIG. 1.

The DC output voltage VOUT 2 of the voltage regulator 12 is divided by the resistors R1˜R5, and the divided voltages are outputted through the voltage followers 131˜134 to the output terminals 23˜26 as the output voltages V1˜V4. Further, the output voltages V1˜V4 are supplied to drivers of a liquid crystal display apparatus (not shown).

The magnitude of the brightness of the display screen of the liquid crystal display apparatus corresponds to the magnitude of each of the output voltages V1˜V4. For example, an external variable resistor may be pre-connected to the adjusting terminals 27 and 28 such that, when the brightness of the display screen is not appropriate, the resistance value of the variable resistor can be finely adjusted. As a result, the resistance value of the resistor R3 changes, and the magnitude of each of the output voltages V1˜V4 accordingly changes, such that the brightness of the display screen is finely adjusted to an appropriate brightness. Alternatively, only when the brightness of the display screen is not appropriate, a variable resistor may be connected to the adjusting terminals 27 and 28 to adjust the brightness.

As described above, in the liquid crystal driving power supply in accordance with the first embodiment, both ends of the resistor R3 are provided with the adjusting terminals 27 and 28 that are connectable to the external adjusting resistor R0. As a result, the output voltages V1˜V4 can be finely adjusted, and thus the brightness of the display screen of the liquid crystal display apparatus can be finely adjusted.

Also, in the liquid crystal driving power supply in accordance with the first embodiment, the switching regulator 11, the voltage regulator 12 and the driver driving voltage generation section 13 are integrated on a semiconductor substrate into an integrated circuit. Accordingly, the mounting area is reduced compared to the case where the driver driving voltage generation section 13 is separately structured. As a result, the overall size of the apparatus can be reduced.

Next, a structure of a liquid crystal driving power supply in accordance with a second embodiment of the present invention will be described below with reference to a circuit diagram shown in FIG. 2.

In the liquid crystal driving power supply in accordance with the second embodiment of the present invention, as shown in FIG. 2, the resistor R3 shown in FIG. 1 is replaced with an electronic volume VR to form a driver driving voltage generation section 13A, and the electronic volume control section 113 in FIG. 1 is replaced with an electronic volume control section 113A.

Accordingly, the electronic volume control section 113A can, in addition to the function of the electronic volume control section 113, receive external control data that controls the resistance value of the electronic volume VR, and supply the received control data to the electronic volume VR.

One embodiment structure of the electronic volume VR is described below with reference to FIGS. 3 and 4.

The electronic volume VR of FIG. 3 has resistors R21˜R24 that are serially connected to one another, and switch elements SW1˜SW4 respectively composed of transistors connected in parallel to the respective resistors R21˜R24. The switch elements SW1˜SW4 are turned ON and OFF by control data provided from the electronic volume control section 113A to obtain required resistance values. In one embodiment, the resistance values of the resistors R21˜R24 may be set at a ratio of numbers obtained by power multiplication of 2, for example, 1, 2, 4 and 8. In this case, resistance values in sixteen stages can be selected.

The electronic volume VR shown in FIG. 4 has resistors R21˜R24 that are connected in parallel with one another. One of the resistors R21 R24 can be selected by a selector 31. The selector 31 switches its contact points by control data provided from the electronic volume control section 113A.

The structure of other sections of the liquid crystal driving power supply of the second embodiment is the same as that of the liquid crystal driving power supply shown in FIG. 1. Therefore, the same components are indicated by the same reference numbers and their descriptions are omitted.

The liquid crystal driving power supply of the second embodiment having the structure described above is provided with the electronic volume VR in a manner that the resistance value of the electronic volume can be controlled by control data from the electronic volume control section 113A. As a result, the output voltages V1˜V4 can be finely adjusted and thus the brightness of the display screen of the liquid crystal display apparatus can be finely adjusted.

Next, a structure of a liquid crystal driving power supply in accordance with a third embodiment of the present invention will be described below with reference to a circuit diagram shown in FIG. 5.

As shown in FIG. 5, the liquid crystal driving power supply in accordance with the third embodiment of the present invention is equipped at least with a switching regulator 11, a voltage regulator 12, a driver driving voltage generation section 13B that generates driving voltages for drivers of a black-and-white or color liquid crystal display apparatus and a power control signal generation section 14, which are integrally formed into an integration circuit (in one-chip) on a semiconductor substrate.

The switching regulator 11 and the voltage regulator 12 have the same structures as those of the first embodiment shown in FIG. 1. Accordingly the same components are indicated by the same reference numbers and the description therefor is omitted.

The driver driving voltage generation section 13B has basically the same structure as that of the driver driving voltage generation section 13 of the first embodiment shown in FIG. 1. Accordingly, the same components are indicated by the same reference numbers and the description therefor is omitted, and different components thereof are described.

The driver driving voltage generation section 13B has voltage followers 131˜134 that function as buffers, are capable of controlling their drivability in response to an externally provided power control signal (to be described below), and are equipped with control terminals to receive the power control signal.

It is noted that the adjusting terminals 27 and 28 provided in the driver driving voltage generation section 13 shown in FIG. 1 are omitted in the driver driving voltage generation section 13B.

The power control signal generation section 14 generates the power control signal based on a liquid crystal alternation signal relating to the display on the liquid crystal display apparatus, to thereby reduce the power consumption of the voltage followers 131˜134 of the driver driving voltage generation section 13B within a range in which the display condition of the liquid crystal display apparatus is acceptable.

More particularly, the power control signal generation section 14 generates a power control signal having a specified width T extending before and after each of a rise and a fall of the liquid crystal alternation signal as shown in FIG. 6(B), when a liquid crystal alternation signal shown in FIG. 6(A) is inputted. The power control signal is supplied to the voltage followers 131˜134. When the power control signal is at “H” level, the voltage followers 131˜134 are placed in a normal operation state. When the power control signal is at “L” level, the voltage followers 131˜134 are placed in a low power consumption operation state.

It is noted that the power control signal generation section 14 is described above as receiving a liquid crystal alternation signal relating to the display of the liquid crystal display apparatus as an input signal. Instead of the liquid crystal alternation signal, a frame signal (to be described below) relating to the display and having characteristics similar to the liquid crystal alternation signal may also be used. Also, the frame signal (to be described below) may be replaced with a liquid crystal alternation signal.

Next, an embodiment structure of the power control signal generation section 14 will be described with reference to a block diagram shown in FIG. 7.

As shown in FIG. 7, the power control signal generation section 14 is equipped at least with a frame counter 141, an AND gate 142, a frame length counter 143, a frame length storing latch 144, a comparator 145, a frame edge detection section 146 and a power control signal generation section 147.

The frame counter 141 counts the number of frame signals FRAM relating to the display on the liquid crystal display apparatus, generates a clock take-in signal S1 for taking in a clock CLOCK to be provided to the frame length counter 143 based on the frame signal FRAM, outputs the clock take-in signal S1 to the AND gate 142, generates an initial value changing signal S2 for setting the initial value of the frame length counter 142 to “0” or “m” and outputs the same to the frame length counter 143.

The frame edge detection section 146 is inputted with the frame signal FRAM and the clock CLOCK, and generates, based thereon, a reset pulse S3 for resetting the counting operation of the frame length counter 143 at each edge of a rise and a fall of the frame signal FRAM and outputs the same to the frame length counter 143. The frame edge detection section 146 also generates a frame edge pulse S4 having a width that is n times the pulse width of the clock CLOCK at the timing at each edge thereof, and outputs the same to the power control signal generation section 147.

The frame length counter 143 counts the period between a rise and a fall of the frame signal FRAM when the clock take-in signal S1 becomes “H” level. A counted value x obtained on completion of the counting is stored in the frame length storing latch 144. Also, after the initial value changing signal S2 becomes “H” level and the counted value x is stored in the frame length storing latch 144, the frame length counter 143 starts the counting from a pre-set initial value m each time a reset pulse S3 is generated.

The comparator 145 compares a counted value that is counted from the initial value m by the frame length counter 143 with the counted value x already stored in the frame length storing latch 144, and provides an output representing a timing when the counted value counted by the frame length counter 143 becomes to be a value (x−m) and concurs with the counted value x stored in the frame length storing latch 144.

The power control signal generation section 147 outputs a power control signal S5 based on an output from the comparator 145 and a frame edge pulse S4 that is outputted by the frame edge detection section 146.

Next, an operation of the third embodiment thus structured will be described with reference to FIGS. 5 and 6.

As shown in FIG. 5, a DC output voltage VOUT 2 of the voltage regulator 12 is divided by the resistors R1˜R5, and the divided voltages are outputted through the voltage followers 131˜134 to the output terminals 23˜26 as output voltages V1˜V4. Further, the output voltages V1˜V4 are supplied to drivers of a liquid crystal display apparatus (not shown).

On the other hand, when a liquid crystal alternation signal shown in FIG. 6(A) is inputted, the power control signal generation section 14 generates a power control signal shown in FIG. 6(B) based on the liquid crystal alternation signal. The power control signal is supplied to the voltage followers 131˜134. When the power control signal is at “H” level, the voltage followers 131˜134 are placed in a normal operation state. When the power control signal is at “L” level, the voltage followers 131˜134 are placed in a low power consumption operation state.

Next, an operation of the power control signal generation section 14 will be described with reference to FIGS. 7 and 8.

When a frame signal FRAM shown in FIG. 8(B) is inputted in the frame counter 141, the frame counter 141 counts the number of the frame signal FRAM at its rises. The frame edge detection section 146 detects each edge of rises and falls of the frame signal FRAM, generates a reset pulse S3 shown in FIG. 8(F) for resetting the counting operation of the frame length counter 143 based on the detection and outputs the same to the frame length counter 143. Also, the frame edge detection section 146 detects each edge of rises and falls of the frame signal FRAM, and generates and outputs a frame edge pulse S4 having a width that is n times the pulse width of the clock CLOCK at the timing of the detection (see FIG. 8(H)).

At time t1, when the frame signal FRAM rises, the clock take-in signal S1 that is outputted from the frame counter 141 shifts from “L” level to “H” level at the rise timing, as shown in FIG. 8(C). As a result, the clock CLOCK is provided through the AND gate 142 to the frame length counter 143 such that the counting becomes possible.

Also, at this moment, the frame edge detection section 146 generates the reset pulse S3 shown in FIG. 8(F), whereby the frame length counter 143 is reset and its initial value is set to zero “0”. When the resetting is completed, the frame length counter 143 starts counting of the clock CLOCK from the initial value of zero “0”. Then, at time t2, when the frame signal FRAM falls, the frame edge detection section 146 detects the fall, a counted value x counted by the frame length counter 143 at this moment is provided to the frame length storing latch 144, and the frame length counter 143 is reset by the reset pulse S3.

At time t3, as shown in FIG. 8(B), when the frame signal FRAM rises, the initial value changing signal S2 that is outputted from the frame counter 141 shifts from “L” level to “H” level, as shown in FIG. 8(D), at the timing of the rise. At this timing, the frame length counter 143 is set with an initial value m, and reset by the reset pulse S3 provided from the frame edge detection section 146.

After the reset is completed, the frame length counter 143 starts counting the clock CLOC from the initial value m. A counted value counted by the frame length counter 143 is compared by the comparator 145 with the counted value x stored in the frame length storing latch 144. At time t4, when the counted value counted by the frame length counter 143 becomes to be (x−m), and concurs with the counted value x stored in the frame length storing latch 144, an output from the comparator 145 shifts from “L” level to “H” level, as shown in FIG. 8(G). As a result, the power control signal S5 that is outputted from the power control signal generation section 147 shifts from “L” level to “H” level, as shown in FIG. 8(I).

Then, at time t5, as shown in FIG. 8(B), when the frame signal FRAM falls, the frame edge detection section 146 detects the fall of the frame signal FRAM, and outputs at the detection a reset pulse S3 and a frame edge pulse S4 shown in FIGS. 8 (F) and (H). When the frame length counter 143 is reset by the reset pulse S3, the frame length counter 143 starts counting the clock CLOCK from the initial value m.

At time t6, when the frame edge pulse S4 that is outputted from the frame edge detection section 14:6 shifts from “H” level to “L” level, as shown in FIG. 8(H), the power control signal S5 that is outputted from the power control signal generation circuit 147 shifts from “H” level to “L” level, as shown in FIG. 8(I).

Then, at time t7, when the counted value of the frame length counter 143 becomes to be (x−m), the output from the comparator 145 shifts from “L” level to “H” level, as shown in FIG. 8(G). As a result, the power control signal S5 that is outputted from the power control signal generation section 147 shifts from “L” level to “H” level, as shown in FIG. 8(I).

Then, at time t8, when the frame signal FRAM rises, as shown in FIG. 8(B), the frame edge detection section 146 detects the rise of the frame signal FRAM, and the reset pulse S3 and the frame edge pulse S4 change by the detection as shown in FIGS. 8(F) and (H). As the frame length counter 143 is reset by the reset pulse S3, the frame length counter 143 starts counting the clock CLOCK from the initial value m.

At time t9, when the frame edge pulse S4 that is outputted from the frame edge detection section 146 shifts from “H” level to “L” level, as shown in FIG. 8(H), the power control signal S5 that is outputted from the power control signal generation section 147 shifts from “H” level to “L” level, as shown in FIG. 8(I).

The operations described above are repeated such that the power control signal S5 that is outputted from the power control signal generation section 147 has a specified width T extending before and after each of rises and falls of the frame signal FRAM (see FIG. 8(I)).

As described above, in the liquid crystal driving power supply in accordance with the third embodiment, a power control signal is generated based on a liquid crystal alternation signal or a frame signal relating to the display on a liquid crystal display apparatus, and the power control signal is supplied to the voltage followers 131˜134. When the power control signal is at “H” level, the voltage followers 131˜134 are placed in a normal operation state. When the power control signal is at “U” level, the voltage followers 131˜134 are placed in a low power consumption operation state. As a result, the reduction of power consumption of the voltage followers 131˜134 is realized within a range in which the display condition of the liquid crystal display apparatus is acceptable, and within a range in which the display condition thereof does not lower.

Also, in the liquid crystal driving power supply in accordance with the third embodiment, the switching regulator 11, the voltage regulator 12, the driver driving voltage generation section 13B, and the power control signal generation section 14 are integrally formed on a semiconductor substrate into an integrated circuit. Accordingly, the mounting area is reduced compared to the case where the driver driving voltage generation section 13B is separately structured. As a result, the overall size of the apparatus can be reduced.

Next, a structure of a liquid crystal driving power supply in accordance with a fourth embodiment of the present invention will be described below with reference to a circuit diagram shown in FIG. 9.

In the liquid crystal driving power supply in accordance with the fourth embodiment of the present invention, the driver driving voltage generation section 13B of the third embodiment shown in FIG. 5 is replaced with a driver driving voltage generation section 13C shown in FIG. 9.

More particularly, in the driver driving voltage generation section 13C, both ends of the resistor R3 are connected to adjusting terminals 27 and 28 that are connectable to an external adjusting resistor R0 for fine adjustment of the brightness of a display screen of a liquid crystal display apparatus, which is different from the structure of the driver driving voltage generation section 13B.

The external adjusting resistor R0 may be formed from a fixed resistor having a fixed resistance value or a variable resistor that is capable of varying its resistance value.

The structure of other sections of the liquid crystal driving power supply of the fourth embodiment is the same as that of the third embodiment shown in FIG. 5. Therefore, the same components are indicated by the same reference numbers and their descriptions are omitted.

As described above, in the liquid crystal driving power supply in accordance with the fourth embodiment, both ends of the resistor R3 are equipped with the adjusting terminals 27 and 28 that are connectable to the external adjusting resistor R0. As a result, when the adjusting resistor R0 is formed from a variable resistor, for example, the output voltages V1˜V4 can be finely adjusted by finely adjusting the resistance value of the variable resistor, and thus the brightness of the display screen of the liquid crystal display apparatus can be finely adjusted.

It is noted that, since the liquid crystal driving power supply in accordance with the fourth embodiment is formed based on the liquid crystal driving power supply in accordance with the third embodiment, the power consumption of the voltage followers 131˜134 of the driver driving voltage generation section 13C can be reduced in a similar manner as the third embodiment.

Also, in the fourth embodiment, both ends of the resistor R3 are equipped with the adjusting terminals 27 and 28 that are connectable to the external adjusting resistor R0. However, the resistor R3 and the electronic volume control section 113 of FIG. 9 may be replaced with an electronic volume VR and an electronic volume control section 113A in a manner provided in the liquid crystal driving power supply shown in FIG. 2, and the resistance value of the electronic volume VR may be controlled by control data provided from the electronic volume control section 113A.

Industrial Applicability

As described above, in accordance with the present invention, the adjusting terminals are connected to the both ends of the second resistor. As a result, when an adjusting resistor is connected to the adjusting terminals, the adjusting resistor is connected in parallel to the second resistor, whereby the resistance value of the second resistor can be changed. Accordingly, for example, when the adjusting resistor is a variable resistor, the resistance value of the second resistor can be finely adjusted and therefore the divided voltages can also be finely adjusted such that the brightness of the display screen of the liquid crystal display apparatus can be finely adjusted.

Also, in accordance with the present invention, the second resistance is formed from an electronic volume that is capable of electronically varying its resistance value based on externally supplied control data. As a result, when the resistance value of the second resistor is finely adjusted based on externally supplied control data, the divided voltages can also be finely adjusted such that the brightness of the display screen of the liquid crystal display apparatus can be finely adjusted.

Furthermore, in accordance with the present invention, the power control signal generation device generates a power control signal based on a liquid crystal alternation signal relating to the display on a liquid crystal display apparatus, and outputs the power control signal to each of the buffers. As a result, the drivability of each of the buffers can be controlled within a range in which the display condition of the liquid crystal display apparatus is permissible, and can reduce the power consumption without lowering the display condition of the liquid crystal display apparatus.

What is claimed is:

1. A liquid crystal driving power supply in which a given voltage is divided by N number of resistors, and the divided voltages are outputted as driving voltages for drives of a liquid crystal display apparatus, the liquid crystal driving power supply characterized in that
the N number of resistors consist of (N−1) number of first resistors having an identical resistance value and a second resistor having a resistance value that is n times the resistance value of the first resistors, the resistors are serially connected to one another in a manner that the second resistor is generally located intermediate among the resistors, and
both ends of the second resistor are connected to adjusting terminals that are connectable to an adjusting resistor.

2. A liquid crystal driving power supply according to claim 1, wherein the adjusting resistor is a variable resistor.

3. A liquid crystal driving power supply in which a given voltage is divided by N number of resistors, and the divided voltages are outputted as driving voltages for drives of a liquid crystal display apparatus, the liquid crystal driving power supply characterized in that
the N number of resistors consist of (N−1) number of first resistors having an identical resistance value and a second resistor having a resistance value that is n times the resistance value of the first resistors, the resistors are serially connected to one another in a manner that the second resistor is generally located intermediate among the resistors, and
the second resistor is an electronic volume that is capable of electronically varying a resistance value thereof based on externally supplied control data.

4. A liquid crystal driving power supply according to claim 3, wherein the electronic volume is formed from a plurality of serially connected units, each of the units having a resistor and a switch element connected in parallel with each other, wherein each of the switch elements can be controlled to turn on and off by externally supplied control data.

5. A liquid crystal driving power supply according to any one of claim 1 through claim 4, wherein the divided voltages are outputted through voltage followers, respectively.

6. A liquid crystal driving power supply in which a given voltage is divided by N number of resistors, and the divided voltages are outputted through buffers respectively as driving voltages for drivers of a liquid crystal display apparatus, the liquid crystal driving power supply characterized in that each of the buffers is capable of controlling a drivability thereof in response to an externally supplied power control signal, and characterized in comprising a power control signal generation device that generates a power control signal based on a liquid crystal alternation signal relative to a display on the liquid crystal display apparatus and outputs the power control signal to the respective buffers.

7. A liquid crystal driving power supply according to claim 6, wherein the power control signal generated by the power control signal generation device has a specified width extending before and after each of rises and falls of the liquid crystal alternation signal.

8. A liquid crystal driving power supply according to claim 6 or claim 7, wherein the power control signal generation device comprises
an edge detection section that detects a rise and a fall of the liquid crystal alternation signal,
a counter section that performs a first count for a period between the rise and the fall of the liquid crystal alternation signal detected by the edge detection section and that, after the completion of the first count and each time when the edge detection section makes a detection of either a rise or a fall of the liquid crystal alternation signal, performs a second count starting from a specified initial value based on the detection,
a latch section that stores a counted value of the first count after the counter section completes the first count,
a comparator section that compares a counted value of the second count by the counter section and the counted value stored in the latch section, and provides an output representing a timing when the counted value of the second count exceeds over the counted value stored in the latch section,
a pulse generation section that, when the edge detection section makes a detection of either a rise or a fall of the liquid crystal alternation signal, generates a pulse having a specified width based on the detection, and
a power control signal generation section that generates the power control signal based on the output of the comparator section and the pulse provided by the pulse generation section.
